(19) United States
(12) Patent Application Publication
(10) Pub. No.: US 2011/0023729 A1
(43) Pub. Date: Feb. 3, 2011

(54) MAGNETIC BLOCK FOR A WATER KNIFE

(75) Inventors: Kenton B. Plaisted, Meridian, ID (US); Michael R. Anderson, Nampa, ID (US)

Correspondence Address: KELLY LOWRY & KELLEY, LLP, 6320 CANOGA AVENUE, SUITE 1650, WOODLAND HILLS, CA, 91367, US

(73) Assignee: J. R. SIMPLOT COMPANY, A NEVADA CORPORATION, Boise, ID (US)

(21) Appl. No.: 12/836,382

(22) Filed: Jul. 14, 2010

Related U.S. Application Data
(60) Provisional application No. 61/229,046, filed on Jul. 28, 2009.

(51) Int. Cl. A47J 43/00; B26D 7/06; B03C 1/02

(52) U.S. Cl. 99/537; 83/402; 210/222

(57) ABSTRACT

A magnetic knife block is provided for temporary installation along a hydraulic flow conduit of a cutting system, in lieu of a conventional hydraulic water knife fixture, for collecting metal debris attributable to construction and/or maintenance activity. The magnetic knife block includes at least one and preferably multiple magnets for collecting metal debris upon initial water flow through the cutting system. The magnetic water knife block is then removable from the hydraulic flow conduit and replaced by the conventional water knife fixture for normal cutting operation, such as cutting a succession of raw potatoes into elongated French fry strips.

### BACKGROUND OF THE INVENTION

This invention relates generally to improvements in devices and methods for cutting food products such as vegetable products, and particularly such as potatoes, into elongated French fry strips or the like. More particularly, this invention relates to a relatively simple yet highly effective magnetic knife block for use in collecting undesirable metal debris and/or loose metal fragments attributable to construction and/or maintenance activity, upon initial water flow through a hydraulic cutting system. Thereafter, the magnetic knife block is removable and replaced by a conventional hydraulic knife fixture for normal cutting operation from lodging within and plugging an inlet throat of the rotary impeller.

Production cutting systems and related knife fixtures are generally well known in the art for cutting vegetable products such as raw potatoes into elongated French fry strips, preparatory to further production processing such as blanching and parfrying. In this regard, one typical production system comprises a hydraulic cutting system wherein a so-called water knife fixture is mounted along the length of an elongated tubular conduit. A pumping device is provided to entrain the vegetable product such as raw potatoes within a propelling water flume for cutting engagement with knife blades of the water knife fixture. The vegetable product is pumped one at a time in relatively rapid single file succession into and through the water conduit with a velocity and sufficient kinetic energy to carry the vegetable product through the knife fixture which severs the product into a plurality of smaller pieces such as elongated French fry strips at a relatively high production rate. The particular size and shape of the cut strips is dictated by the geometry of the knife blades, and these cut strips are carried further through a discharge conduit for appropriate subsequent processing, including cooking, freezing, and packaging steps. Examples of such hydraulic cutting systems and related water knife fixtures are found in U.S. Pat. Nos. 3,109,468; 3,116,772; 3,208,625; 4,082,024; 4,135,002; 4,372,184; 4,423,652; 5,904,083; 6,041,682; 6,457,393; 6,805,030 and 7,117,778, all of which are incorporated by reference herein.

One common problem associated with hydraulic cutting systems and related water knife fixtures relates to the presence of undesirable metal debris or metal fragments attributable to initial construction and/or maintenance activities. In this regard, grinding, welding, and/or drilling steps can produce potentially dangerous metal debris. Use of wire brushes and small fasteners can also generate metal fragments. Removal of such metal debris and/or metal fragments from the hydraulic cutting system prior to through-put processing of food products is extremely desirable.

Accordingly, there exists a significant need to an apparatus and method for removing undesirable metal debris and/or metal fragments from the hydraulic cutting system prior to use of the system to cut food products. The present invention fulfills this need and provides further related advantages.

### SUMMARY OF THE INVENTION

In accordance with the invention, a magnetic knife block is provided for temporary installation along a flow conduit of a hydraulic cutting system, in lieu of a conventional hydraulic water knife fixture, for collecting metal debris attributable to construction and/or maintenance activity. The magnetic knife block includes at least one and preferably multiple magnets for collecting metal debris upon initial water flow through the cutting system. The magnetic water knife block is then quickly and easily removable from the hydraulic flow conduit and replaced by the conventional water knife fixture for normal cutting operation, such as cutting a succession of raw potatoes into elongated French fry strips.

In one preferred form, the magnetic knife block comprises at least one and preferably multiple tubes oriented to extend across a water flow path through the knife block. Each such tube carries an internally mounted magnet for collecting and/or magnetically entrapping undesirable metal debris and fragments upon initial water flow through the cutting system. Thereafter, the magnetic knife block is removed from the flow conduit and replaced by a standard or conventional water knife fixture having cutting blades for cutting vegetable products such as potatoes into elongated strips, such as elongated French fry strips.

In one alternative preferred form of the invention, multiple magnets are carried on a common base for installation together into a corresponding plurality of tubes extending respectively across the conduit flow path.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic diagram depicting an hydraulic cutting system of a type utilizing an hydraulic knife fixture, and adapted for use of the magnetic knife block constructed in accordance with the present invention;

FIG. 2 is an end elevation view of a magnetic knife block constructed in accordance with the present invention;

FIG. 3 is a side elevation view of the magnetic knife block shown in FIG. 2; and

FIG. 4 is an elevation view of a modified embodiment of the magnetic knife block, illustrating an alternative preferred form for removably mounting multiple magnets thereon.

### DETAILED DESCRIPTION OF THE PREFERRED EMBODIMENTS

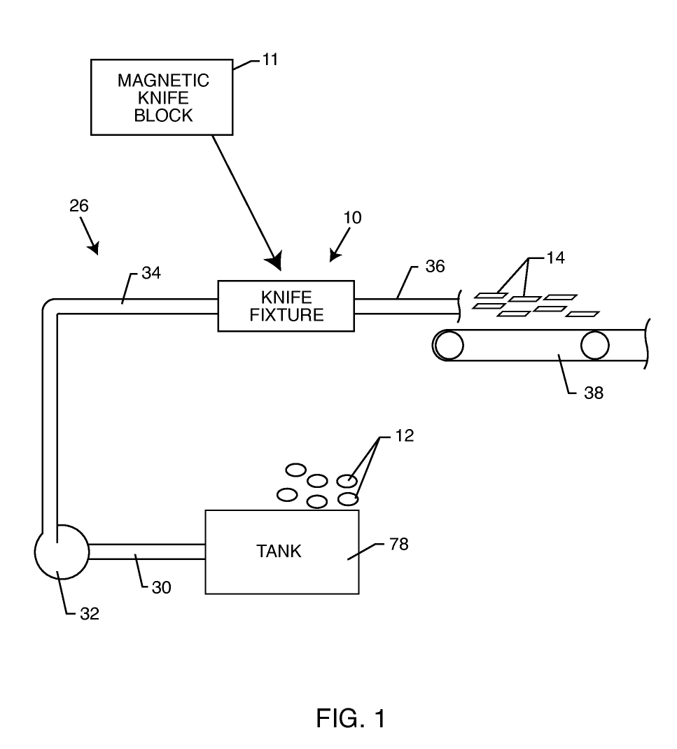

As shown in the exemplary drawings, an hydraulic cutting system comprises a conventional so-called water knife fixture referred to generally in FIG. 1 by the reference numeral 10 to cutting vegetable products such as whole potatoes 12 into elongated strips 14, such as French fry strips for subsequent processing. The present invention comprises a magnetic knife block 11 for temporary installation into the cutting system, in lieu of the water knife fixture 10, for collecting unwanted metal fragments and/or metal debris arising from construction and/or maintenance activities. After use the of the magnetic knife block 11, the block 11 is replaced quickly and easily by the conventional water knife fixture 10 for normal production cutting of the elongated strips 14.

FIG. 1 shows the hydraulic cutting system to comprise a tank 78 or the like for receiving a supply of vegetable products, such as the illustrative raw whole potatoes 12. These potatoes 12 are delivered via an inlet conduit 30 to a pump 32 which propels the potatoes in single file relation within a propelling water stream or flume through a tubular delivery conduit 34 into cutting engagement with blades (not shown) of the water knife fixture 10. In a typical cutting system, the potatoes are propelled through the delivery conduit 34 at a relatively high velocity of about 40-60 feet per second to provide sufficient kinetic energy whereby each potato is propelled through the knife fixture 10 to produce the desired elongated cut strips 14. In this regard, the delivery conduit 34 may include a centering alignment device (not shown) for substantially centering each potato 12 on a longitudinal centerline of the flow passage extending through the associated knife fixture 10, in a manner known to persons skilled in the art. The cut strips 14 travel through a short discharge conduit 36 to a conveyor 38 or the like which transports the cut strips 14 for further processing, such as blanching, drying, batter coating, parfrying, freezing, etc.

The present invention recognizes that small quantities of undesirable metal debris and/or metal fragments can be generated within the cutting system during initial construction, or during subsequent maintenance activities. Such metal pieces are, of course, extremely undesirable and potentially dangerous if mixed with the cut food product. Accordingly, in the past, prevention of metal debris generation and/or cleaning of the conduit surfaces have been a primary consideration before cutting food products.

The magnetic knife block 11 of the present invention provides a simple and easy-to-use device for removing metal fragments from the hydraulic conduit before cutting of food products. In general, the magnetic knife block 11 is mounted along the length of the hydraulic conduit 34 in lieu of the knife fixture 10, and functions to magnetically collect any metal fragments or metal debris. In this regard, upon installation, water is initially pumped (without entrained food products 12) through the hydraulic cutting system, and thus through the magnetic knife block 11. Individual magnets provided within the knife block 11 attract and collect such metal pieces. Thereafter, the magnetic knife block 11 is quickly and easily removed and replaced by the conventional knife fixture 10 for cutting food products 12.

Alternately, in the event of suspected contamination of the cut food products 12 by metal fragments and the like, the magnetic knife block 11 of the present invention can be used as an investigative tool to determine such contamination and collect any such metal fragments. In such use, the knife fixture 10 can be removed from the cutting system and temporarily replaced with the magnetic knife block 11 of the present invention. Water is then delivered through the cutting system, including the magnetic knife block 11, wherein the knife block 11 effectively and efficiently captures and thereby removes any metal debris from the cutting system flow paths.

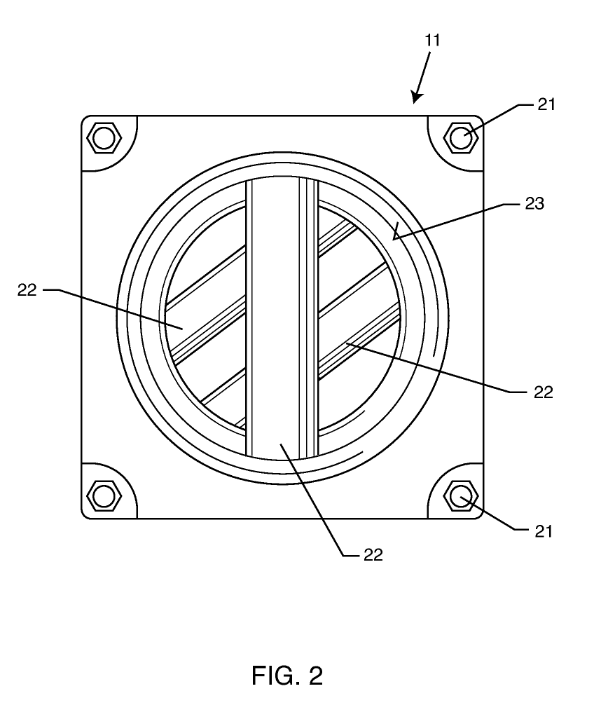

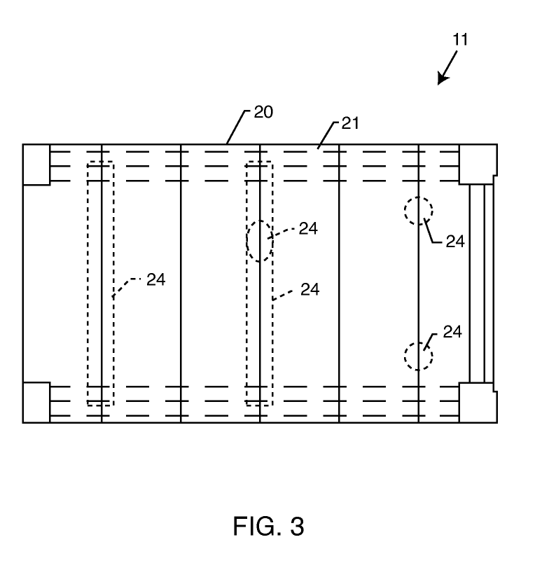

FIGS. 2-3 show the magnetic knife block 11 in one preferred form. As shown, the magnetic knife block 11 generally comprises a tubular housing 20 adapted for quick and easy installation along the flow conduit 34, 36 by means of appropriate fasteners such as bolts 21. At least one and preferably multiple tubular sleeves 22 (FIG. 2) extend transversely across a flow passage 23 extending longitudinally through the housing 20, preferably at axially spaced positions, with at least some of these sleeves 22 being radially offset from a centerline of the flow passage 23 whereby a pair of sleeves 22 can be positioned in spaced-apart relation at a common axial position. Each sleeve 22 carries internally a magnet 24 (FIG. 3) designed for magnetically attracting and collecting metal fragments and the like.

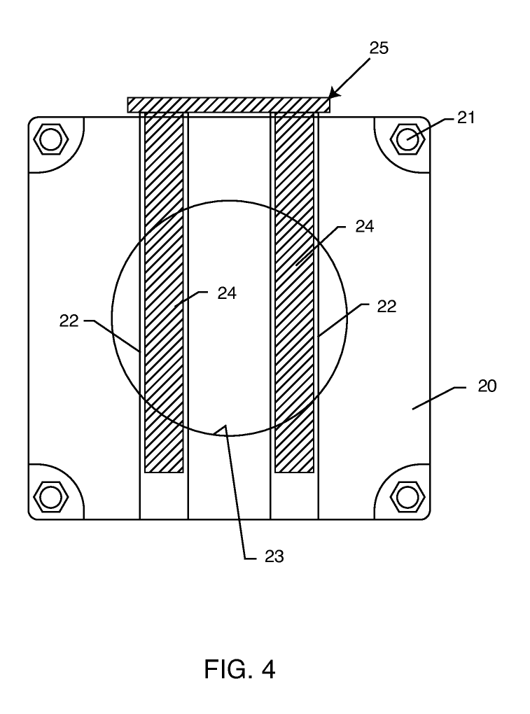

The magnets 24 comprise relatively high strength or high power magnets each providing a strong force field to attract and collect metal pieces. Preferred magnet materials include, by way of example, alnico, rare earth magnets such as neodymium or samarium cobalt, ferrite, bonded, flexible, and/or electro-magnets. Each magnet 24 is protectively encased within an associated one of the transversely extending sleeves 22, in close proximity with the flowing water through the magnetic knife block 11 to entrap and collect metal particles. In this regard, as shown in one alternative preferred form in FIG. 4, each magnet 24 is preferably mounted onto a laterally extending base strip 25 or the like at one side of the housing 20, to facilitate removal from the sleeve 22 for cleaning, inspection, and/or replacement. Multiple magnets 24 can be coupled to a common base strip 25 for quick and easy removal from the associated sleeves 22.

A variety of modifications and improvements in and to the magnetic knife block 11 of the present invention will be apparent to those persons skilled in the art. Accordingly, no limitation on the invention is intended by way of the foregoing description and accompanying drawings, except as set forth in the appended claims.

What is claimed is:

1. In a food product cutting system having a fluid conduit for directing the food product carried in a fluid medium along a flow path, and a knife unit installed along the flow path for cutting the food product into pieces, a magnetic block for initial temporary installation along the flow path to collect metal for collecting metal debris prior to installation of said knife unit, said magnetic block comprising:
at least one magnet extending generally across the flow path for collecting metal debris upon initial fluid flow through said flow path;
said magnetic block being removable from said flow path and replaceable by said knife unit for cutting the food product into pieces.

2. The magnetic block of claim 1 wherein said at least one magnet is mounted within a tube oriented to extend across said flow path.

3. The magnetic block of claim 1 wherein said at least one magnet comprises a plurality of magnets extending across said flow path.

4. The magnetic block of claim 3 wherein each of said plurality of magnets is mounted within a respective tube oriented to extend across said flow path.

5. The magnetic block of claim 1 wherein the food product comprises potatoes.

6. The magnetic block of claim 1 wherein said fluid comprises water.

7. The magnetic block of claim 1 further comprising a housing having a size and shape for mounting in-line along said flow path, and bolt means for removably securing said housing relative to said flow conduit.

8. The magnetic block of claim 7 further comprising at least one sleeve extending generally transversely across said flow path, when said housing is installed in-line with said flow path, said at least one sleeve having said at least one magnet carried therein.

9. The magnetic block of claim 8 wherein said at least one sleeve comprises a plurality of sleeves axially spaced along said flow path, when said housing is installed in-line with said flow path, and wherein each of said sleeves has a respective magnet carried therein.

10. The magnetic block of claim 9 wherein said respective magnets are each connected to a common base strip at one side of said housing to facilitate removal of said magnets as a group from said respective sleeves.

11. The magnetic block of claim 1 wherein said at least one magnet is selected from the group consisting essentially of alnico, rare earth, ferrite, bonded, flexible and electro magnets.

12. A cutting system, comprising:
a fluid conduit for directing a food product carried in a fluid medium along a flow path;
a magnetic block for initial installation in-line with said flow path and including at least one magnet extending generally across the flow path for collecting metal debris upon initial fluid flow through said flow path;
said magnetic block being removable from said flow path and replaceable by a knife unit installed along the flow path for cutting the food product into pieces.

13. The cutting system of claim 12 wherein said at least one magnet of said magnetic block is mounted within a tube oriented to extend across said flow path.

14. The cutting system of claim 12 wherein said at least one magnet of said magnetic block comprises a plurality of magnets extending across said flow path.

15. The cutting system of claim 14 wherein each of said plurality of magnets of said magnetic block is mounted within a respective tube oriented to extend across said flow path.

16. The cutting system of claim 12 wherein the food product comprises potatoes and further wherein said fluid comprises water.

17. The cutting system of claim 12 wherein said magnetic block further comprises a housing having a size and shape for mounting in-line along said flow path, and bolt means for removably securing said housing relative to said flow conduit.

18. The cutting system of claim 17 wherein said magnetic block further comprises at least one sleeve extending generally transversely across said flow path, when said housing is installed in-line with said flow path, said at least one sleeve having said at least one magnet carried therein.

19. The cutting system of claim 18 wherein said at least one sleeve of said magnetic block comprises a plurality of sleeves axially spaced along said flow path, when said housing is installed in-line with said flow path, and wherein each of said sleeves has a respective magnet carried therein.

20. The cutting system of claim 19 wherein said respective magnets of said magnetic block are each connected to a common base strip at one side of said housing to facilitate removal of said magnets as a group from said respective sleeves.
